(19) United States
(12) Patent Application Publication
(10) Pub. No.: US 2025/0211145 A1
(43) Pub. Date: Jun. 26, 2025

(54) METHOD FOR CONTROLLING AN ELECTRIC MOTOR IN THE EVENT OF A SPEED MEASUREMENT ANOMALY

(71) Applicant: ARIANEGROUP SAS, Les Mureaux (FR)

(72) Inventors: François MALRAIT, Vernon Cedex (FR); Vincent LEBOEUF, Vernon Cedex (FR); Antoine ROMET, Vernon Cedex (FR)

(73) Assignee: ARIANEGROUP SAS, Les Mureaux (FR)

(21) Appl. No.: 18/850,415

(22) PCT Filed: Mar. 24, 2023
(86) PCT No.: PCT/FR2023/050426

§ 371 Date: Sep. 24, 2024

(30) Foreign Application Priority Data
Mar. 25, 2022 (FR) FR2202661

(51) Int. Cl. H02P 21/00; H02P 21/18; H02P 25/022

(52) U.S. Cl. CPC H02P 21/0021; H02P 21/18; H02P 25/022; H02P 2207/055

(57) ABSTRACT

Method for controlling a synchronous electric motor including a generation of a torque reference from a mechanical setpoint, a measurement of the position and a determination of the speed of the motor, a measurement of the current generated by the motor, a generation of the voltage references from the torque reference, and a generation of the control voltages from the reference voltages. It includes a monitoring of an anomaly in the position measurement, an adaptation of the electrical control gains as a function of the detection or non-detection of an anomaly in the measurement of the position of the electric motor, and in that the voltage references depend on the values of the electrical control gains.

### TECHNICAL FIELD

The invention concerns the control of an electric motor and more particularly the control of an electric motor following an anomaly in the measurement of the speed of its rotor.

### PRIOR ART

For a control system configured to control an electric motor configured in speed or in position, a rotor speed sensor is generally used in order to construct a robust and efficient control law.

When the position information becomes unusable, the system becomes inoperative due to lack of information replacing the measurement. When the anomaly occurs during a controlled movement, it is necessary to react instantly to continue the movement and maintain the expected level of performance.

There are different methods for controlling an electric motor without a sensor which can be classified into two categories: on the one hand, the methods operating from the electrical quantities as applied or measured on an electric motor, the electrical quantities being able to be instantaneous quantities or quantities averaged over a period of time which depends on the power stage and its control strategy and, on the other hand, the methods operating from high-frequency components of the electrical quantities, superadded to the main control.

As schematically illustrated in FIG. 1, the principle of controlling an electric motor without a position sensor from the fundamental electrical quantities comprises a motor driven in voltage by an electric controller. The electric controller receives as input a measurement of the current in the motor, a value of the motor speed estimated from the voltage and current of the motor and a mechanical torque reference provided by a mechanical controller, the mechanical controller determining the mechanical torque reference from a speed or position reference, the speed estimation and control parameters of the electric controller.

As schematically illustrated in FIG. 2, the principle of controlling an electric motor without a position sensor from high-frequency electrical quantities differs from the principle of FIG. 1 in that it comprises a high-frequency module upstream of the motor and that the estimation made is done on the speed or position of the motor.

In the definition of the architectures of the known electrical systems, the presence of a position or speed measurement is known at the time of configuration of the control system. It is in this phase that the choice is made of a controller that manages or not the position or speed measurement.

Either the control law is configured to operate with the information given by the position sensor, or the control law is configured to operate without this information. The reconfiguration from one to the other can only be done after a shutdown phase. This induces that the current movement ends in an uncontrolled manner. A faulty position/speed measurement value will, through the regulation, generate voltages on the motor which do not correspond to the state of the motor. This can lead to a set of inappropriate behaviors that will need to be captured through different monitoring functions.

In the known systems, when a fault is detected, it is only proposed to generate a warning or a fault.

### DISCLOSURE OF THE INVENTION

The main aim of the present invention is therefore to propose a solution for reconfiguring the motor control mode on the fly, to compensate for the failure of a motor position sensor. On-the-fly reconfiguration of the motor control mode means reconfiguration in operation, that is to say reconfiguration of the motor control mode while maintaining the motor and its control means in operation.

In a first object of the invention, a method for controlling a synchronous electric motor is proposed, comprising a generation of a mechanical torque reference from a mechanical setpoint, a measurement of the position and a determination of the speed of the electric motor from the position measurement, a measurement of the current generated by the electric motor, a generation of the voltage references from the mechanical torque reference, and a generation of the control voltages from the reference voltages.

The method further comprises a monitoring of an anomaly in the measurement of the position of the electric motor, an adaptation of the electrical control gains as a function of the detection or non-detection of an anomaly in the measurement of the position of the electric motor, the generated voltage references depending on the values of the electrical control gains.

The method according to the invention thus makes it possible to provide continuity of control of the voltage of the electric motor even in the presence of a major failure that is the loss of information on the measurement of the position of the motor. The detection of the failure then the reconfiguration of the electrical control means through the adaptation of the gains, and alternatively of the current reference, makes it possible to guarantee the performance of the mechanical movement of the electric motor. And this without having to stop the motor, and without having to stop the control, that is to say without having to turn off and reset the control of the motor.

The monitoring of an anomaly in the measurement of the position of the electric motor further includes a control of the consistency of the position or speed information with the current information.

Current information means the data from the current measurements and from the transformations of the current measurements.

In one aspect of the method, the monitoring of an anomaly in the measurement of the position of the electric motor comprises an estimation of the speed of the electric motor from the speed determined from the measurement of the position and of the current measured across the motor, a comparison of the estimated speed with the determined speed, and a reporting of a measurement anomaly as a function of the result of the comparison relative to a detection threshold.

According to another object of the invention, there is proposed an electrical control system for a synchronous electric motor comprising a mechanical control block configured to receive a mechanical setpoint and deliver a mechanical torque reference, an electrical control block configured to deliver a voltage reference as a function of the torque reference delivered by the mechanical control block, a power block configured to deliver a control voltage to the electric motor as a function of the voltage reference delivered by the electrical control block, a position sensor of the rotor of the electric motor that said electrical system controls, and means for measuring the current across the electric motor controlled by the electrical control system.

According to one general characteristic of the system according to the invention, the electrical control block further comprises:
a means for detecting an anomaly in the measurement of the position sensor,
a module for adapting the electrical control gains configured to adapt the gains as a function of the detection or non-detection of an anomaly in the measurement of the position of the electric motor, and
a control module configured to deliver voltage references from the mechanical torque reference, the current measured across the electric motor, and the electrical control gains delivered by the adaptation module (94).

In a first aspect of the system according to the invention, the anomaly detection means comprises a module for estimating the speed of the motor from the voltage and current of the motor, a comparator configured to compare the determined speed with the speed measured by the sensor, and a module for reporting a measurement anomaly as a function of the result of the comparison relative to a detection threshold.

In a second aspect of the system according to the invention, the power control block further comprises a power converter.

According to another object of the invention, there is proposed an electrical system comprising an electric motor coupled to a load, and an electrical control system as defined above coupled to the electric motor.

### BRIEF DESCRIPTION OF THE DRAWINGS

Other characteristics and advantages of the present invention will emerge from the description given below, with reference to the appended drawings which illustrate one exemplary embodiment devoid of any limitation.

FIG. 1 schematically represents an electrical system 1 including a synchronous electric motor 2 and a control circuit 4 according to one embodiment of the invention.

FIG. 2 schematically presents in more detail an electrical control system 4 for the synchronous electric motor 2 of FIG. 1.

FIG. 3 is a schematic representation in more detail of an electrical control block 9 of FIG. 2.

FIG. 4 schematically presents a flowchart of a control method implemented by the electrical control system 4 for the synchronous electric motor 2 according to one mode of implementation of the invention.

### DESCRIPTION OF THE EMBODIMENTS

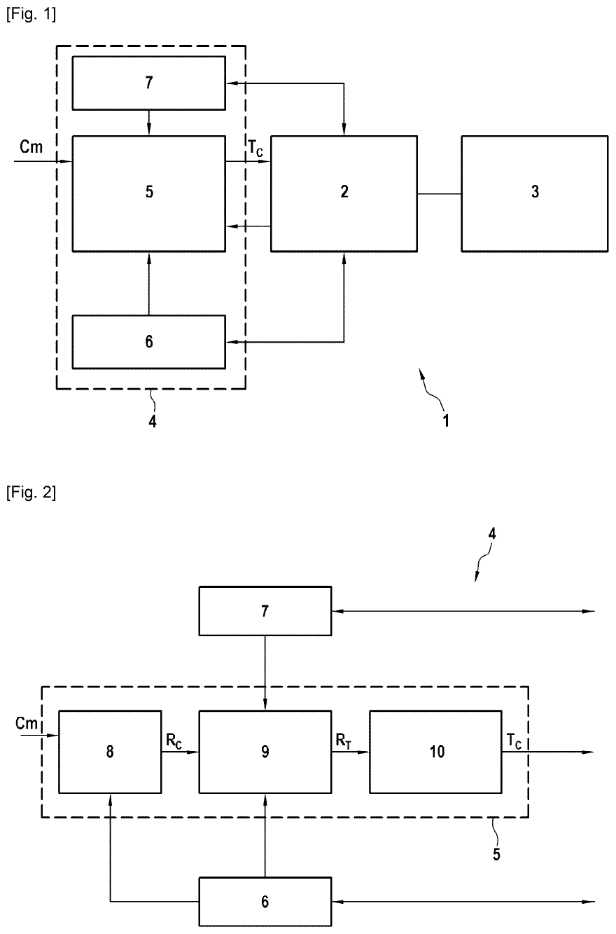

FIG. 1 schematically represents an electrical system 1 comprising a synchronous electric motor 2 with permanent magnets, coupled to a load 3 and an electrical control system 4 coupled to the electric motor 2.

The electrical control system 4 for the synchronous electric motor 2 comprises a control assembly 5, a position sensor 6 configured to measure the speed of the rotor of the synchronous electric motor 2, and means for measuring the voltage and the current across the synchronous electric motor 2.

As illustrated in FIG. 2 which schematically presents in more detail an electrical control system 4 for the synchronous electric motor 2, the control assembly 5 comprises a mechanical control block 8 configured to receive a mechanical setpoint Cm and deliver a mechanical torque reference R_{C}, an electrical control block 9 configured to deliver a voltage reference R_{T} as a function of the torque reference R_{C} delivered by the mechanical control block 8, and a power block 10 configured to deliver a control voltage T_{C} to the electric motor 2 as a function of the voltage reference R_{T} delivered by the electrical control block 9.

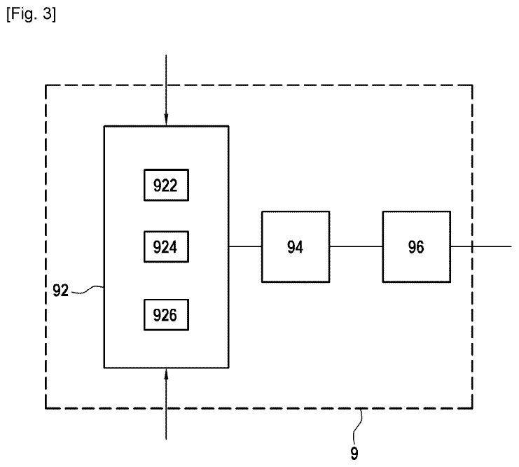

As illustrated in FIG. 3 which schematically represents an electrical control block 9 in more detail, the electrical control block 9 comprises a means 92 for detecting an anomaly in the measurement of the position sensor 6, a module 94 for adapting the electrical control gains configured to adapt the gains as a function of the detection or non-detection of an anomaly in the measurement of the position of the synchronous electric motor 2, a control module 96 configured to deliver voltage references R_{T} from the mechanical reference R_{C}, the current measured across the electric motor 2 by the current measuring means 7, and the electrical control gains delivered by the adaptation module 94.

Furthermore, the anomaly detection means 92 comprises a module 922 for estimating the speed of the motor from the voltage and current of the motor, a comparator 924 configured to compare the speed determined with the speed measured by the position sensor 6, and a module 926 for reporting a measurement anomaly as a function of the result of the comparison relative to a detection threshold.

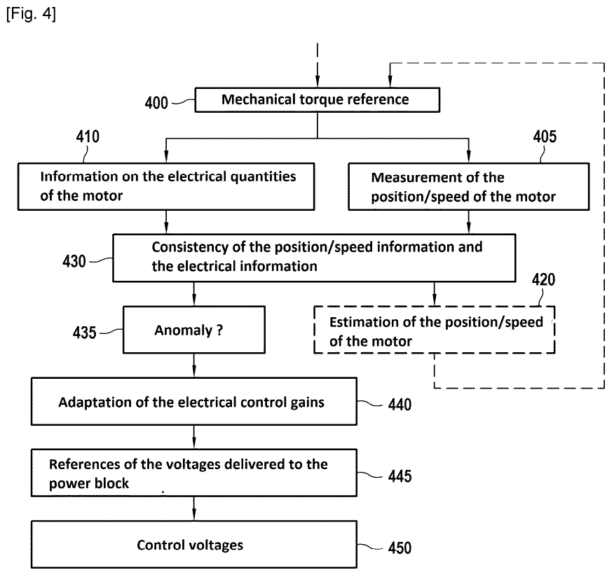

FIG. 4 represents a flowchart of a control method implemented by the electrical control system 4 for the synchronous electric motor 2. The method comprises a first step 400 of generating a mechanical torque reference from a mechanical setpoint. In a second step 405, a measurement of the position is then carried out using the position sensor 6 and a determination of the speed of the electric motor 2 is carried out from the position measurement, and, in a step 410, a measurement of the current generated by the electric motor 2 is carried out.

A monitoring of the anomaly in the measurement of the position sensor 6 is then carried out. For this, in a step 430, the consistency of the position or speed information with the current information is controlled, and it is determined whether there is an anomaly or not, in a step 435, between said information. The information consistency control comprises in particular an estimation of the speed or position of the motor from the electrical quantities such as the current generated by the motor and a comparison of this estimated speed or this estimated position relative to the measured position or a speed determined from the measured position, this comparison can be carried out by calculating the difference between the estimated speed and the measured speed and by checking that this gap remains limited to an expected range of variation with regard to the measurement noise and to the regulation dynamics.

Following the control of the consistency of the information, it is possible to deliver, in a step 420, an estimation of the speed of the electric motor 2 from the measurements of the position and of the current measured across the motor in particular.

In a following step 445, the voltage references for the selected electrical control gains are delivered to the power block 10.

Finally, in a step 450, the voltage block delivers a control voltage to the synchronous electric motor 2.

The estimation of the speed of the synchronous electric motor 2 with permanent magnets from the electrical quantities (voltage and current) of the electric motor can be carried out in different ways.

The following mathematical model represents a modeling of a synchronous electric motor with surface permanent magnets (without salience) with the physical quantities of three phases S1, S2, S3, with the resistor R_{S}, the current i on each of the phases i_{S1}, i_{S2}, i_{S3}, and the voltage on each of the phases uₛ₁, u_{S2}, uₛ₃, and the electrical flux on each of the phases φ_{S1}, φ_{S2}, φ_{S3}.

$$\frac{d}{dt} {φ}_{S 1} + Rs {i}_{S 1} = {u}_{S 1} \qquad [ Math 1 ]$$

$$\frac{d}{dt} {φ}_{S 2} + Rs {i}_{S 2} = {u}_{S 2} \qquad [ Math 2 ]$$

$$\frac{d}{dt} {φ}_{S 3} + Rs {i}_{S 3} = {u}_{S 3} \qquad [ Math 3 ]$$

With the flux φ expressed by the magnetic coupling matrix equation:

$$( \begin{matrix}{φ}_{S 1} \\ {φ}_{S 2} \\ {φ}_{S 3}\end{matrix} ) = ( \begin{matrix}L & M & M \\ M & L & M \\ M & M & L\end{matrix} ) \cdot ( \begin{matrix}{i}_{S 1} \\ {i}_{S 2} \\ {i}_{S 3}\end{matrix} ) + {ϕ}_{M} \cdot ( \begin{matrix}cos ( θ ) \\ cos ( θ - \frac{2 π}{3} ) \\ cos ( θ - \frac{4 π}{3} )\end{matrix} ) \qquad [ Math 4 ]$$

With M representing the mutual stator inductance value, L representing the value of the stator self-inductance, ϕ_{M} representing the permanent flux value, and θ representing the position of the magnet. And the electromagnetic torque Σ_{EM} expressed by the following equation:

$${τ}_{EM} = - {n}_{P} \cdot {ϕ}_{M} \cdot ( {i}_{S 1} \cdot sin ( θ ) + {i}_{S 2} \cdot sin ( θ - \frac{2 π}{3} ) + {i}_{S 3} \cdot sin ( θ - \frac{4 π}{3} ) ) \qquad [ Math 5 ]$$

With n_{P} representing the number of pairs of poles.

In steady state, the quantities (uₛ₁, u_{S2}, uₛ₃) are sinusoidal quantities phase shifted by 2π/3.

It is known by construction of the electric machine that i_{S1}+i_{S2}+iₛ₃=0.

By applying the Clarke transform to the three-phase quantities, that is to say by applying the following two transformation matrices:

$${P}_{123 \to α β γ} = \frac{2}{3} \cdot ( \begin{matrix}1 & - \frac{1}{2} & - \frac{1}{2} \\ 0 & \frac{\sqrt{3}}{2} & - \frac{\sqrt{3}}{2} \\ \frac{\sqrt{2}}{2} & \frac{\sqrt{2}}{2} & \frac{\sqrt{2}}{2}\end{matrix} ) \qquad [ Math 6 ]$$

$${P}_{α β γ \to 123} = ( \begin{matrix}1 & 0 & \frac{\sqrt{2}}{2} \\ - \frac{1}{2} & \frac{\sqrt{3}}{2} & \frac{\sqrt{2}}{2} \\ - \frac{1}{2} & - \frac{\sqrt{3}}{2} & \frac{\sqrt{2}}{2}\end{matrix} ) \qquad [ Math 7 ]$$

we can define for each quantity X a new vector of coordinates (or variables):

$$( \begin{matrix}{x}_{α} \\ {x}_{β} \\ {x}_{γ}\end{matrix} ) = {P}_{123 \to α β γ} \cdot ( \begin{matrix}{x}_{1} \\ {x}_{2} \\ {x}_{3}\end{matrix} ) . \qquad [ Math 8 ]$$

We get the relations:

$$\frac{d}{dt} {φ}_{S α} + Rs {i}_{S α} = {u}_{S α} \qquad [ Math 9 ]$$

$$\frac{d}{dt} {φ}_{S β} + Rs {i}_{S β} = {u}_{S β} \qquad [ Math 10 ]$$

$$\frac{d}{dt} {φ}_{S γ} + Rs {i}_{S γ} = {u}_{S γ} \qquad [ Math 11 ]$$

With by construction that i_{Sχ}=0, and

$$( \begin{matrix}{φ}_{S α} \\ {φ}_{S β} \\ {φ}_{S γ}\end{matrix} ) = ( \begin{matrix}{L}_{dq} & 0 & 0 \\ 0 & {L}_{dq} & 0 \\ 0 & 0 & {L}_{γ}\end{matrix} ) \cdot ( \begin{matrix}{i}_{S α} \\ {i}_{S β} \\ {i}_{S γ}\end{matrix} ) + {ϕ}_{M} \cdot ( \begin{matrix}cos ( θ ) \\ sin ( θ ) \\ 0\end{matrix} ) \qquad [ Math 12 ]$$

$${τ}_{EM} = \frac{3}{2} \cdot {n}_{P} \cdot {i}_{S α S γ}^{T} \cdot ( \begin{matrix}- sin ( θ ) \\ cos ( θ ) \\ 0\end{matrix} ) \cdot {ϕ}_{M} \qquad [ Math 13 ]$$

where L_{dq}=L−M, and L_{γ}=L+2.M.

This model shows that the third component has no functional role to the extent that the current quantity is zero and that this component does not intervene in the torque generation. There comes the writing of the conventional two-phase system:

$$\frac{d}{dt} {φ}_{S α} + Rs {i}_{S α} = {u}_{S α} \qquad [ Math 14 ]$$

$$\frac{d}{dt} {φ}_{S β} + Rs {i}_{S β} = {u}_{S β} \qquad [ Math 15 ]$$

With by construction that i_{Sχ}=0, and

$${φ}_{S α} = {L}_{dq} {i}_{S α} + {Φ}_{M} \cdot cos ( θ ) \qquad [ Math 16 ]$$

$${φ}_{S β} = {L}_{dq} {i}_{S β} + {Φ}_{M} \cdot sin ( θ ) \qquad [ Math 17 ]$$

$${τ}_{EM} = \frac{3}{2} {n}_{p} ( - sin ( θ ) \cdot {i}_{S α} + cos ( θ ) \cdot {i}_{S α} + cos ( θ ) \cdot {i}_{S β} ) {Φ}_{M} \qquad [ Math 18 ]$$

In steady state, the quantities (u_{Sα}, u_{Sβ}) are sinusoidal quantities phase shifted by π/2.

By substituting the flux variables, we obtain the equations of the permanent magnet synchronous motor without saliences:

$${L}_{dq} \frac{d}{dt} {i}_{S α} = {u}_{S α} + ω \cdot {Φ}_{M} \cdot sin ( θ ) - Rs {i}_{S α} \qquad [ Math 19 ]$$

$${L}_{dq} \frac{d}{dt} {i}_{S β} = {u}_{S β} - ω \cdot {Φ}_{M} \cdot cos ( θ ) - Rs {i}_{S β} \qquad [ Math 20 ]$$

$$\frac{d}{dt} θ = ω \qquad [ Math 21 ]$$

$${τ}_{EM} = \frac{3}{2} {n}_{p} ( - sin ( θ ) \cdot {i}_{S α} ( θ ) ) {Φ}_{M} \qquad [ Math 22 ]$$

The following model represents in matrix form a synchronous electric motor with permanent magnets in the following fixed reference frame:

$$\frac{d}{dt} θ = ω \qquad [ Math 23 ]$$

$${L}_{dq} \frac{d}{dt} ( \begin{matrix}{i}_{S α} \\ {i}_{S β}\end{matrix} ) = - {R}_{S} \cdot ( \begin{matrix}{i}_{S α} \\ {i}_{S β}\end{matrix} ) - ω \cdot 𝕁 \cdot R ( θ ) \cdot ( \begin{matrix}{Φ}_{M} \\ 0\end{matrix} ) + ( \begin{matrix}{u}_{S α} \\ {u}_{S β}\end{matrix} ) \qquad [ Math 24 ]$$

$${τ}_{EM} = \frac{3}{2} {n}_{p} {( 𝕁 \cdot R ( θ ) \cdot ( \begin{matrix}{Φ}_{M} \\ 0\end{matrix} ) )}^{T} \cdot ( \begin{matrix}{i}_{S α} \\ {i}_{S β}\end{matrix} ) \qquad [ Math 25 ]$$

With the following notations:

$${u}_{Sa β} = ( \begin{matrix}{u}_{S α} \\ {u}_{S β}\end{matrix} ) , \qquad [ Math 26 ]$$

the voltage of the motor,

$${i}_{Sα β} = ( \begin{matrix}{i}_{S α} \\ {i}_{S β}\end{matrix} ) \qquad [ Math 27 ]$$

the current of the motor, θ, the position of the magnet, ω, the speed of the magnet, and the matrices:

$$( \begin{matrix}0 & - 1 \\ 1 & 0\end{matrix} ) , \qquad [ Math 28 ]$$

$$ℝ ( Δθ ) = cos Δθ \cdot 𝕀 + sin Δ θ \cdot 𝕁 = ( \begin{matrix}cos Δθ & - sin Δθ \\ sin Δθ & cos Δθ\end{matrix} ) . \qquad [ Math 29 ]$$

In established mechanical and electrical states, the system reaches the stationary equilibrium. The motor rotates at speed ω=dθ/dt under a load torque constraint τ_{EM}=τ_{LOAD}. The following expression of the torque:

$${τ}_{EM} = \frac{3}{2} \cdot {n}_{p} \cdot {( 𝕁 \cdot R ( θ ) \cdot ( \begin{matrix}{Φ}_{M} \\ 0\end{matrix} ) )}^{T} \cdot ( \begin{matrix}{i}_{S α} \\ {i}_{S β}\end{matrix} ) \qquad [ Math 30 ]$$

allows expressing the current in a general form:

$$( \begin{matrix}{i}_{S α} \\ {i}_{S β}\end{matrix} ) = R ( θ ) \cdot ( \begin{matrix}{I}_{D} \\ {I}_{Q}\end{matrix} ) \qquad [ Math 31 ]$$

With

$${I}_{Q} = \frac{{τ}_{EM}}{\frac{3}{2} \cdot {n}_{p} \cdot {ϕ}_{M}} \qquad [ Math 32 ]$$

and I_{D} any value (which is often set by the controller).

Then comes the expression:

$$ω \cdot 𝕁 \cdot R ( θ ) \cdot ( \begin{matrix}{I}_{D} \\ {I}_{Q}\end{matrix} ) = - {R}_{S} \cdot R ( θ ) \cdot ( \begin{matrix}{I}_{D} \\ {I}_{Q}\end{matrix} ) - ω \cdot 𝕁 \cdot R ( θ ) \cdot ( \begin{matrix}{Φ}_{M} \\ 0\end{matrix} ) + ( \begin{matrix}{u}_{S α} \\ {u}_{S β}\end{matrix} ) \qquad [ Math 33 ]$$

which allows writing

$$( \begin{matrix}{u}_{S α} \\ {u}_{S β}\end{matrix} ) = R ( θ ) \cdot ( \begin{matrix}{U}_{D} \\ {U}_{Q}\end{matrix} ) \qquad [ Math 34 ]$$

With the variables

$$( \begin{matrix}{U}_{D} \\ {U}_{Q}\end{matrix} ) = ω \cdot 𝕁 \cdot {L}_{dq} \cdot ( \begin{matrix}{I}_{D} \\ {I}_{Q}\end{matrix} ) + {R}_{S} \cdot ( \begin{matrix}{I}_{D} \\ {I}_{Q}\end{matrix} ) + ω \cdot 𝕁 \cdot ( \begin{matrix}{Φ}_{M} \\ 0\end{matrix} ) \qquad [ Math 35 ]$$

In practice, it is not possible to specifically know the phase θ from the electrical signals taken individually. It is possible to estimate the pulsation of electrical signals, an image of the speed, that is to say the derivative of the position.

To estimate the speed from the phase of the electrical quantities, it is sufficient to calculate the angle of the voltage vector with a direct calculation of the inverse of the tangent function for example.

It is also possible to use a PLL (Phase lock loop) type algorithm.

In all cases, there is a phase shift φ between the phase of the electrical quantities and the position of the rotor (which depends on the control strategy in the first place) which must be taken into account in the previous expressions of the rotating reference frame. There comes:

$$( \begin{matrix}{i}_{S α} \\ {i}_{S β}\end{matrix} ) = R ( θ - φ ) \cdot ( \begin{matrix}{I}_{D} \\ {I}_{Q}\end{matrix} ) \qquad [ Math 36 ]$$

$$( \begin{matrix}{u}_{S α} \\ {u}_{S β}\end{matrix} ) = R ( θ - φ ) \cdot ( \begin{matrix}{U}_{D} \\ {U}_{Q}\end{matrix} ) \qquad [ Math 37 ]$$

$$and$$

$$( \begin{matrix}{U}_{D} \\ {U}_{Q}\end{matrix} ) = ω \cdot 𝕁 \cdot {L}_{dq} \cdot ( \begin{matrix}{I}_{D} \\ {I}_{Q}\end{matrix} ) + {R}_{S} \cdot ( \begin{matrix}{I}_{D} \\ {I}_{Q}\end{matrix} ) + ω \cdot 𝕁 \cdot R ( φ ) \cdot ( \begin{matrix}{Φ}_{M} \\ 0\end{matrix} ) \qquad [ Math 38 ]$$

The speed of the electric motor can also be determined from the amplitudes of the electrical quantities. From the expression [Math 38], an estimation of the speed can also be extracted, this time based on the amplitude of the voltage, of the current, by solving the following equation:

$${( ( {U}_{D} - {R}_{S} \cdot {I}_{D} ) + ω \cdot {L}_{dq} \cdot {I}_{Q} )}^{2} + {( ( {U}_{Q} - {R}_{S} \cdot {I}_{Q} ) - ω \cdot {L}_{dq} \cdot {I}_{D} )}^{2} = {ω}^{2} \cdot {ϕ}_{M}^{2} \qquad [ Math 39 ]$$

that is to say

$$( {ϕ}_{M}^{2} - {L}_{dq}^{2} \cdot ( {I}_{D}^{2} + {I}_{Q}^{2} ) ) \cdot {ω}^{2} + 2 \cdot {L}_{dq} \cdot ( {I}_{D} \cdot {U}_{Q} - {I}_{Q} \cdot {U}_{D} ) \cdot ω - {( {U}_{D} - {R}_{S} \cdot {I}_{D} )}^{2} - {( {U}_{Q} - {R}_{S} \cdot {I}_{Q} )}^{2} = 0 \qquad [ Math 40 ]$$

$$and$$

$${ω}_{\pm } = \frac{( - {L}_{dq} \cdot {P}_{R} \pm \sqrt{{L}_{dq}^{2} \cdot {P}_{R}^{2} + ( {ϕ}_{M}^{2} - {L}_{dq}^{2} \cdot {I}^{2} ) ( {U}^{2} - 2 \cdot {R}_{S} \cdot {P}_{A} + {R}_{S}^{2} \cdot {I}^{2} )} )}{( {ϕ}_{M}^{2} - {L}_{dq}^{2} \cdot {I}^{2} )} \qquad [ Math 41 ]$$

With:

$${P}_{R} = {I}_{D} \cdot {U}_{Q} - {I}_{Q} \cdot {U}_{D} \qquad [ Math 42 ]$$

$${P}_{A} = {I}_{D} \cdot {U}_{D} + {I}_{Q} \cdot {U}_{Q} \qquad [ Math 43 ]$$

$${I}^{2} = {I}_{D}^{2} + {I}_{Q}^{2} \qquad [ Math 44 ]$$

$${U}^{2} = {U}_{D}^{2} + {U}_{Q}^{2} \qquad [ Math 45 ]$$

Note that there is no objection to using the quantities in the fixed reference frame instead of a rotating reference frame in the previous formulas.

The previous expression gives two solutions (one positive, one negative). It is possible to remove the indeterminacy by selecting the speed that has the sign consistent with the direction of the movement of the voltage vector (if its phase increases or decreases).

By taking the model of the motor in the fixed reference frame (equations [Math 23] and [Math 24]), to construct a dynamic estimation, we choose to consider a reference frame rotating at the speed:

$$\frac{d}{dt} \hat{θ} = \hat{ω} \qquad [ Math 46 ]$$

with:

$$( \begin{matrix}{i}_{S α} \\ {i}_{S β}\end{matrix} ) = R ( \hat{θ} ) \cdot ( \begin{matrix}{I}_{D} \\ {I}_{Q}\end{matrix} ) \qquad [ Math 47 ]$$

$$( \begin{matrix}{u}_{S α} \\ {u}_{S β}\end{matrix} ) = R ( \hat{θ} ) \cdot ( \begin{matrix}{U}_{D} \\ {U}_{Q}\end{matrix} ) \qquad [ Math 48 ]$$

We then have:

$$\frac{d}{dt} θ = ω \qquad [ Math 49 ]$$

$$\frac{d}{dt} \hat{θ} = \hat{ω} \qquad [ Math 50 ]$$

$${L}_{dq} \frac{d}{dt} ( \begin{matrix}{I}_{D} \\ {I}_{Q}\end{matrix} ) = - ( {R}_{S} \cdot 𝕀 + {L}_{dq} \cdot \hat{ω} \cdot 𝕁 ) \cdot ( \begin{matrix}{I}_{D} \\ {I}_{Q}\end{matrix} ) - ω \cdot 𝕁 \cdot R ( θ - \hat{θ} ) \cdot ( \begin{matrix}{Φ}_{M} \\ 0\end{matrix} ) + ( \begin{matrix}{U}_{D} \\ {U}_{Q}\end{matrix} ) \qquad [ Math 51 ]$$

We can then construct the observer:

$${L}_{dq} \frac{d}{dt} ( ) = - ( {R}_{S} \cdot 𝕀 + {L}_{dq} \cdot \hat{ω} \cdot 𝕁 ) \cdot ( ) - \hat{ω} \cdot 𝕁 \cdot ( \begin{matrix}{Φ}_{M} \\ 0\end{matrix} ) + ( \begin{matrix}{U}_{D} \\ {U}_{Q}\end{matrix} ) + {𝕂}_{P} \cdot ( ( \begin{matrix}{I}_{D} \\ {I}_{Q}\end{matrix} ) - ( ) ) \qquad [ Math 52 ]$$

$$\frac{d}{dt} \hat{ω} = {𝕂}_{I}^{T} \cdot ( ( \begin{matrix}{I}_{D} \\ {I}_{Q}\end{matrix} ) - ( ) ) \qquad [ Math 53 ]$$

It remains to define the structure of the gains [symbol] which guarantees that the quantity \hat{ω}, corresponding to the estimation of the speed, tends towards ω. With the notation δX=X−\hat{X}, then the difference between the motor model and the observer can be written:

$$\frac{d}{dt} δθ = δω \qquad [ Math 54 ]$$

$${L}_{dq} \cdot \frac{d}{dt} δ ( \begin{matrix}{I}_{D} \\ {I}_{Q}\end{matrix} ) = - ( {R}_{S} \cdot 𝕀 + {L}_{dq} \cdot \hat{ω} \cdot 𝕁 + {𝕂}_{P} ) \cdot δ ( \begin{matrix}{I}_{D} \\ {I}_{Q}\end{matrix} ) + ω \cdot ( \begin{matrix}{ϕ}_{M} \\ 0\end{matrix} ) \cdot δθ - δω \cdot 𝕁 \cdot ( \begin{matrix}{ϕ}_{M} \\ 0\end{matrix} ) + O ( ϵ ) \qquad [ Math 55 ]$$

$$\frac{d}{dt} δω = - {𝕂}_{I}^{T} \cdot δ ( \begin{matrix}{I}_{D} \\ {I}_{Q}\end{matrix} ) \qquad [ Math 56 ]$$

The choice:

$${𝕂}_{P} = - {R}_{S} \cdot 𝕀 + {K}_{PQ} \cdot 𝕁 \qquad [ Math 57 ]$$

$${𝕂}_{I} = ( \begin{matrix}0 \\ {K}_{IQ}\end{matrix} ) \qquad [ Math 58 ]$$

leads to:

$${L}_{dq} \cdot \frac{d}{dt} δ {I}_{D} = ( {L}_{dq} \cdot \hat{ω} + {K}_{PQ} ) \cdot δ {I}_{Q} + ω \cdot {ϕ}_{M} \cdot δθ \qquad [ Math 59 ]$$

$${L}_{dq} \cdot \frac{d}{dt} δ {I}_{Q} = - ( {L}_{dq} \cdot \hat{ω} + {K}_{PQ} ) \cdot δ {I}_{D} - {ϕ}_{M} \cdot δω \qquad [ Math 60 ]$$

$$\frac{d}{dt} δω = - {K}_{IQ} \cdot δ {I}_{Q} . \qquad [ Math 61 ]$$

The classic study of this system shows the convergence of the speed estimator based on the electrical quantities [Math 53] towards the actual speed.

The comparison between on the one hand the information obtained by the speed measurement, and on the other hand the information obtained by a speed estimation makes it possible to validate the consistency of the position or speed measurement. The speed estimation can be directly a value obtained from the electrical quantities, for example [Math 41] or [Math 52]; it is also possible to use a static or dynamic combination of the speed measurement and speed estimation from the electrical quantities. The validation of the consistency consists, for example, in calculating the gap between the two pieces of information, and in defining an acceptable threshold of difference between these two estimations, which must be equal in steady state, for example 1 Hz.

A conventional control of the permanent magnet electric motor consists in calculating a reference voltage vector in the following control reference frame:

$$( \begin{matrix}{U}_{D}^{REF} \\ {U}_{Q}^{REF}\end{matrix} ) = ω \cdot 𝕁 \cdot {L}_{dq} \cdot ( \begin{matrix}{I}_{D}^{REF} \\ {I}_{Q}^{REF}\end{matrix} ) + {R}_{S} \cdot ( \begin{matrix}{I}_{D}^{REF} \\ {I}_{Q}^{REF}\end{matrix} ) + \hat{ω} \cdot 𝕁 \cdot ( \begin{matrix}{ϕ}_{M} \\ 0\end{matrix} ) + ( \begin{matrix}{U}_{CTRL - D} \\ {U}_{CRTL - Q}\end{matrix} ) \qquad [ Math 62 ]$$

$${ω}_{S} = \hat{ω} \qquad [ Math 63 ]$$

$$\frac{d}{dt} {θ}_{S} = {ω}_{S} \qquad [ Math 64 ]$$

With

$$( \begin{matrix}{U}_{CTRL - D} \\ {U}_{CRTL - Q}\end{matrix} ) = {𝕂}_{CTRL - P} \cdot ( \begin{matrix}{I}_{D}^{REF} - {I}_{D} \\ {I}_{Q}^{REF} - {I}_{Q}\end{matrix} ) + ( \begin{matrix}{U}_{ID} \\ {U}_{IQ}\end{matrix} ) \qquad [ Math 65 ]$$

$$\frac{d}{dt} ( \begin{matrix}{U}_{ID} \\ {U}_{IQ}\end{matrix} ) = {𝕂}_{CTRL - I} \cdot ( \begin{matrix}{I}_{D}^{REF} - {I}_{D} \\ {I}_{Q}^{REF} - {I}_{Q}\end{matrix} ) \qquad [ Math 66 ]$$

where

$$( \begin{matrix}{U}_{D}^{REF} \\ {U}_{Q}^{REF}\end{matrix} )$$

corresponds to the reference voltage, ω_{S} corresponds to the where pulsation of the control reference frame, θ_{S} corresponds to the pulsation of the control reference frame,

$$( \begin{matrix}{I}_{D}^{REF} \\ {I}_{Q}^{REF}\end{matrix} )$$

corresponds to the reference current,

$$( \begin{matrix}{I}_{D} \\ {I}_{Q}\end{matrix} )$$

corresponds to the current of the motor in the control reference frame, and \hat{ω} corresponds to the estimated speed of the motor.

The gain matrices [symbol] _{CTRL-P} and [symbol] _{CTRL-I} must be calculated to ensure the control performance. This performance depends on the dynamics of the estimated speed. It is appropriate to determine a set of gains ( [symbol] _{CTRL-P}, [symbol] _{CTRL-I}) by speed estimation strategy, whether the estimated speed of the motor comes from the measurement, or from an estimation strategy from the electrical quantities, or from a mixture of the two.

The reference voltage is then transformed into the three voltages to be applied to the phases of the motor, in two steps:
from a rotation of the angle of the control reference frame:

$$( \begin{matrix}{U}_{α}^{REF} \\ {U}_{β}^{REF}\end{matrix} ) = ( \begin{matrix}cos {θ}_{S} & - sin {θ}_{S} \\ sin {θ}_{S} & cos {θ}_{S}\end{matrix} ) \cdot ( \begin{matrix}{U}_{D}^{REF} \\ {U}_{Q}^{REF}\end{matrix} ) \qquad [ Math 67 ]$$

then with [Math 7]

$$( \begin{matrix}{u}_{S 1} \\ {u}_{S 2} \\ {u}_{S 3}\end{matrix} ) = {P}_{αβγ \to 123} \cdot ( \begin{matrix}{U}_{α}^{REF} \\ {U}_{β}^{REF} \\ 0\end{matrix} ) \qquad [ Math 68 ]$$

The invention thus makes it possible to provide continuity of control of the voltage of the electric motor even in the presence of a major failure that is the loss of information on the measurement of the position of the motor. The detection of the failure then the reconfiguration of the electrical control means through the adaptation of the gains, and alternatively of the current reference, makes it possible to guarantee the performance of the mechanical movement of the electric motor.

In other words, the invention consists in reconfiguring the motor control mode on the fly to compensate for a failure of the position sensor, by controlling the movement. This on-the-fly reconfiguration is enabled by the invention thanks to a control of the consistency of the speed/position information with regard to the electrical measurements, and to an adaption of the controller as a function of this measurement consistency.

The invention thus proposes a control of the consistency of the speed/position information with regard to the electrical measurements thus allowing a detection of a position measurement anomaly from an electrical/mechanical behavioral analysis, a reconfiguration of the electric and mechanical controllers to control the movement, and an adaptive control between a control means with the speed/position measurement information and a control means with the information on the measurements of the electrical quantities, without speed/position measurement information.

1. A method for controlling a synchronous electric motor,
comprising a generation of a mechanical torque reference from a mechanical setpoint, a measurement of the position of the electric motor and a determination of the speed of the electric motor from the position measurement, a measurement of the current generated by the electric motor, a generation of the voltage references from the mechanical torque reference, and a generation of the control voltages from the reference voltages,
wherein it further comprises a monitoring of an anomaly in the measurement of the position of the electric motor, an adaptation of the electrical control gains as a function of the detection or non-detection of an anomaly in the measurement of the position of the electric motor, and in that the voltage references depend on the values of the electrical control gains, the monitoring of an anomaly in the measurement of the position of the electric motor including a control of the consistency of the position or speed information with the current information.

2. The method according to claim 1, wherein the monitoring of an anomaly in the measurement of the position of the electric motor comprises an estimation of the speed of the electric motor from the speed determined from the measurement of the position and of the current measured across the motor, a comparison of the estimated speed with the measured speed, and a reporting of a measurement anomaly as a function of the result of the comparison relative to a detection threshold.

3. An electrical control system for a synchronous electric motor comprising a mechanical control block configured to receive a mechanical setpoint and deliver a mechanical torque reference, an electrical control block configured to deliver a voltage reference as a function of the torque reference delivered by the mechanical control block, a power block configured to deliver a control voltage to the electric motor as a function of the voltage reference delivered by the electrical control block, a position sensor of the rotor of the electric motor that said electrical control system controls, and means for measuring the current across the electric motor controlled by said electrical control system,
wherein the electrical control block further comprises:
a means for detecting an anomaly in the measurement of the position sensor via a control of the consistency of the position or speed information with the current information,
a module for adapting the electrical control gains configured to adapt the gains as a function of the detection or non-detection of an anomaly in the measurement of the position of the electric motor,
a control module configured to deliver voltage references from the mechanical torque reference, the current measured across the electric motor, and the electrical control gains delivered by the adaptation module.

4. The electrical control system according to claim 3, wherein the anomaly detection means comprises a module for estimating the speed of the motor from the voltage and current of the motor, a comparator configured to compare the determined speed with the speed measured by the sensor, and a module for reporting a measurement anomaly as a function of the result of the comparison relative to a detection threshold.

5. The electrical control system according to claim 3, wherein the power control block further comprises a power converter.

6. An electrical system comprising a synchronous electric motor coupled to a load, and an electrical control system according to claim 3, coupled to the synchronous electric motor.
